(19) United States
(12) Patent Application Publication
(10) Pub. No.: US 2003/0056121 A1
(43) Pub. Date: Mar. 20, 2003

(54) Authentication method of computer program stored in medium

(76) Inventors: Yousuke Kimoto, Kanagawa (JP); Izumi Kawanishi, Tokyo (JP); Toyoshi Okada, Tokyo (JP); Muneki Shimada, Tokyo (JP); Tadashi Nakamura, Kanagawa (JP); Kenjiro Komaki, Saitama (JP); Kazuhiro Kanee, Chiba (JP); Makoto Kubo, Tokyo (JP); Mitsuhiro Nakamura, Tokyo (JP); Ryoichi Shibuya, Tokyo (JP); Yasuo Sasaki, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/187,305

(22) Filed: Jul. 1, 2002

(30) Foreign Application Priority Data
Sep. 14, 2001 (JP) 2001-280775
May 23, 2002 (JP) 2002-149799

(51) Int. Cl. H04L 9/32

(52) U.S. Cl. 713/202

(57) ABSTRACT

A client terminal device at a user side transmits a plurality of IDs in an arbitrary arrangement order to an authentication server machine on a network on the basis of a device environment of the user when a license authentication for software is performed. The authentication server machine performs the license authentication using an authentication program and ID issue program corresponding to the software for which the license authentication is applied, and issues an ID in the ID form corresponding to the software.

This application is related to Japanese Patent application No. 2001-280775 filed on Sep. 14, 2001, and No. 2002-149799 filed May 23, 2002, based on which this application claims priority under the Paris Convention and the contents of which are incorporated herein by reference.

### BACKGROUND OF THE INVENTION

1. Field of the Invention

The present invention relates to an authentication method, a storage medium having stored therein an authentication program, an authentication program, an authentication server machine, a client terminal device, and an authentication system preferably provided in a license authentication system for performing a license authentication of a computer program stored in a medium such as an optical disk, a semiconductor memory, or the like, where the optical disk includes a CD-ROM, a DVD-ROM or the like.

2. Description of the Related Art

At present, in order to prevent an unauthorized copy of a computer program, when the computer program is used or the computer program is installed, software which impose a license authentication on a user have increased. The license authentication is generally performed with the following procedure.

When the user mounts a medium having stored therein a desired computer program on a client terminal device, the client terminal device reads out the computer program from the mounted medium in the form of a so-called Auto Run, stores it in a secondary storage medium such as, for example, a hard disk, reads out a program of an authentication wizard from the medium, and displays an image of the authentication wizard on a monitor device according to this program.

On this image, input columns of a “present date” detected on the basis of a timer provided in the client terminal device, an “install identification number (install ID)” individually attached to each medium, and a “confirmation identification number (confirmation ID)” notified from an administration center side for the user when the license for the computer program is approved are displayed.

The user notifies the “present date” and the “install ID” to the administration center side via a network or a telephone on the basis of display contents of such an image.

The administration center confirms the “present date” notified from the user, and collates the “install ID” notified from the user with an install ID of each medium stored in a database, so that a verification is performed as to whether or not the install ID notified from the user is legitimate and whether or not the install was performed from the media of the install ID in the past.

When it is determined that the install ID notified from the user is a legitimate install ID and the install of the computer program has not been performed from the medium of the install ID, the administration center notifies the “confirmation ID” which approves the license of the computer program via the network or the telephone for the user, and performs registrations of the “present date”, the “install ID”, “information indicating to be installed” and the “confirmation ID” in the database.

Next, the user inputs the “confirmation ID” notified from this administration center in the input column of the confirmation ID of the image. Thereby, the license authentication procedure is terminated.

When such a license authentication procedure is not legitimately terminated, the client terminal device restricts a use of all the functions of the installed computer program. Or, the client terminal device restricts a use of part of the functions by allowing display of a file, but inhibiting from creating and editing a file, for example.

Therefore, when the user desires to use all the functions of the computer program, he or she needs to legitimately terminate the license authentication procedure. Accordingly, imposing a license authentication procedure on the user can perform the prevention of the unauthorized copy of the computer program.

However, in the authentication system for performing a conventional license authentication procedure in such a manner, information collected from the user are fixed in advance, which are, for example, the “present date”, the “install ID” attached to the medium, and the like. And, the authentication system itself for performing the license authentication on the basis of the fixedly collected information is also fixedly configured. Therefore, there has been a problem that the authentication system cannot flexibly correspond to the changes of a specification.

### SUMMARY OF THE INVENTION

The present invention has been made in view of the above problems, and it is an object to provide an authentication method, a storage medium having stored therein an authentication program, an authentication program, an authentication server machine, a client terminal device, and an authentication system capable of flexibly corresponding to the changes of the specification.

In the authentication system according to the present invention, when an authentication application is performed from the client terminal device, the authentication server machine selects an authentication program or an identification information issue program corresponding to the applied authentication target and performs an authentication processing or an issue processing of identification information. Thereby, it is possible to flexibly correspond to the changes of the specification of the authentication method or the issue form of the identification information in the client terminal device.

### BRIEF DESCRIPTION OF DRAWINGS

FIG. 1 is a diagram showing a schematic system configuration of an authentication system according to an embodiment to which the present invention is applied;

FIG. 2 is a diagram showing a software system configuration of an authentication server machine provided in the authentication system according to the embodiment;

FIG. 3 is a diagram for describing storage contents of an application management table stored in an authentication database of the authentication server machine;

FIG. 4 is a diagram showing a software system configuration of a client terminal device provided in the authentication system according to the embodiment;

FIG. 5 is a diagram showing a data configuration of an authentication information packet transmitted from the client terminal device to the authentication server machine;

FIG. 6 is a diagram for describing a sequence order of authentication information in the authentication information packet;

FIG. 7 is a flow chart for describing a flow of a license authentication processing in the authentication system according to the embodiment;

FIG. 8 is a diagram showing a data configuration of an authentication result information packet returned from the authentication server machine to the client terminal device;

FIG. 9 is a flow chart showing a flow from when a license authentication is applied to when a processing for software is performed on the basis of a license authentication result in a client terminal device of an authentication system according to an application example;

FIG. 10 is a diagram for describing contents of the authentication information packet transmitted from the client terminal device to the authentication server machine in the authentication system according to the application example;

FIG. 11 is a flow chart showing a flow from when the authentication information is received to when the authentication result information is returned in the authentication server machine of the authentication system according to the application example;

FIG. 12 is a diagram for describing storage contents of a registration ID management table provided in the authentication database of the authentication server machine in the authentication system according to the application example; and

FIG. 13 is a diagram for describing contents of the authentication result information returned from the authentication server machine to the client terminal device in the authentication system according to the application example.

### DETAILED DESCRIPTION OF THE PREFERRED EMBODIMENT

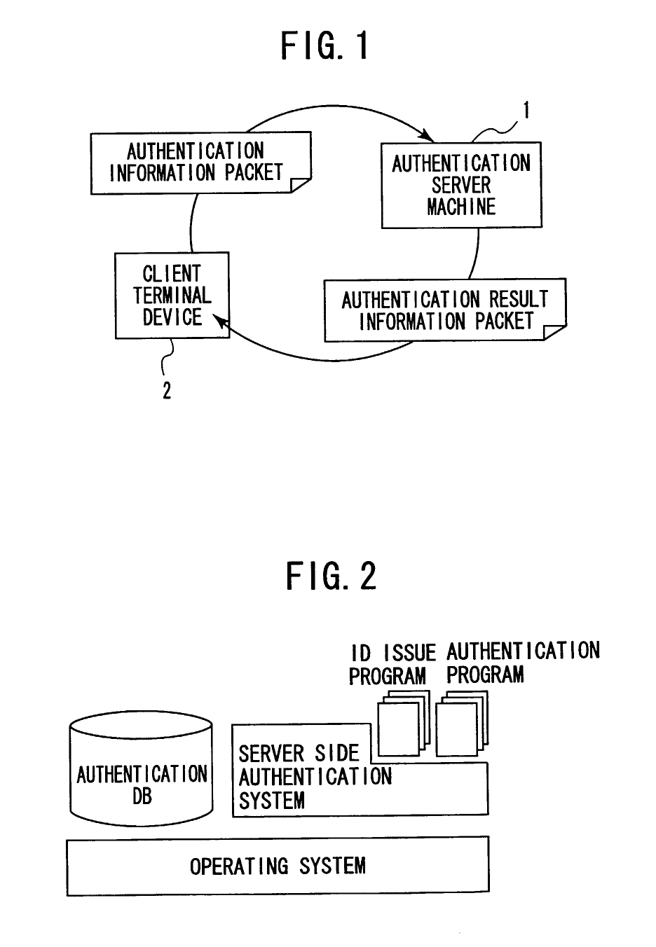

The present invention can be applied to an authentication system as shown in FIG. 1.

Configuration of Authentication System

An authentication system shown in FIG. 1 comprises an authentication server machine 1 which is connected to a predetermined network such as the Internet, and performs various authentication processings such as a license authentication of a software, a processing for authenticating whether a user thereof is a legitimate user which is a target of a predetermined service, and a client terminal device 2 of each user similarly connected to a predetermined network.

Further, the client terminal device 2 transmits an authentication information packet including information used in the above authentication processing to the authentication server machine 1, and the authentication server machine 1 transmits an authentication result information packet including information on an authentication result performed on the basis of the received authentication information packet.

In the authentication system shown in FIG. 1, an encryption communication utilizing SSL (Secure Socket Layer) or the like is enabled between the authentication server machine 1 and the client terminal device 2. Configuration of Authentication Server Machine

The above authentication server machine 1 comprises, as shown in FIG. 2, an operating system for realizing a basic operation of the authentication server machine 1, a server side authentication system, and an authentication database (authentication DB) as main components.

The above server side authentication system has a plurality of types of ID issue programs corresponding to issue forms of identification information (ID) of an authentication target, and a plurality of types of authentication programs provided for each authentication target.

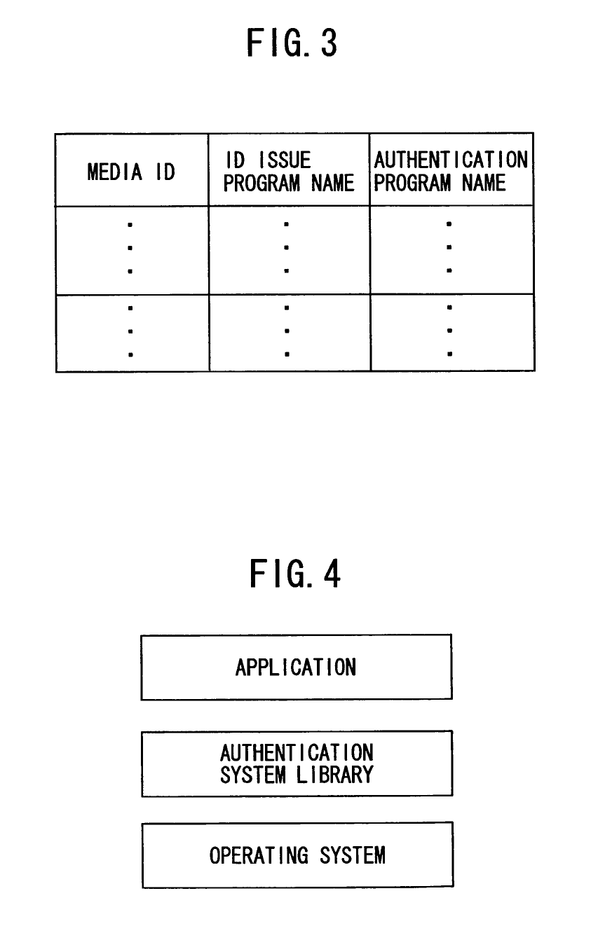

The above authentication DB stores information used for ID issue information or at an authentication processing. Further, in the case the authentication server machine 1 performs license authentication of software (application), the authentication DB stores an application management table which authentication method and ID issue program used for each software is described. Specifically, the application management table has a configuration as shown in FIG. 3, and stores a software ID (=media ID. Software name is also usable) for specifying software, an ID issue program name, and an authentication program name used when the license authentication of the software is performed in the form of table and in correspondence to each software.

Configuration of Client Terminal Device

The above client terminal device 2 is configured with a video game device having a network interface, and a secondary storage medium such as a hard disk drive (HDD), or a personal computer device, or the like, and has, as shown in FIG. 4, an operating system for realizing a basic operation of the client terminal device 2, an authentication system library, and an application for realizing a predetermined function.

The above authentication system library acquires authentication information corresponding to the authentication target from the client terminal device 2 or the client terminal device 2 and peripheral devices thereof, and transmits it to the authentication server machine 1.

The above authentication information may be input by the user. Further, the above authentication information is preferably user specifiable information, and can include a unique ID (media ID) uniquely attached to a storage medium in which a MAC address (Media Access Control address) or an application is stored, or numeric denoting a user's birthday or alphabets of the user name.

Authentication Application Operation of Client Terminal Device

In the authentication system having such a configuration, when an authentication application for a desired authentication target is performed, the user operates the client terminal device 2 to input (or select) the authentication target. According to the input of the authentication target, the authentication system library in the client terminal device 2 operates as follows. The authentication system library may be configured to be automatically activated when the user inputs the authentication target (Auto Run).

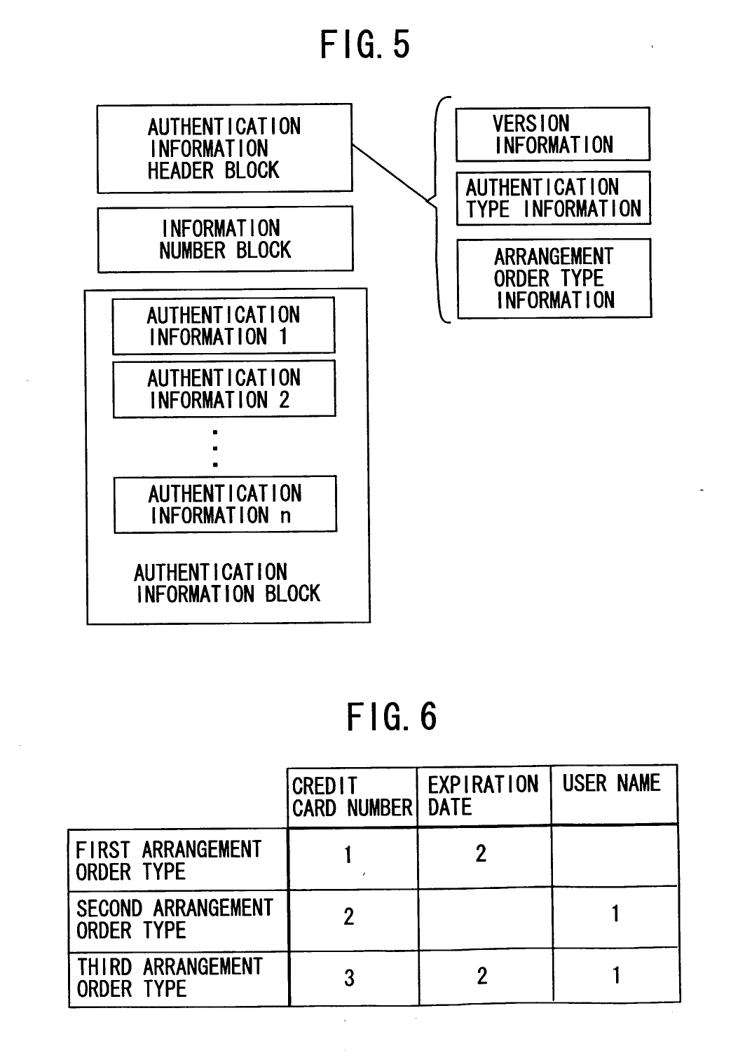

At first, when the authentication target is input by the user, the authentication system library acquires a plurality of authentication information (authentication information 1 to authentication information n (n shows natural number)) corresponding to the input authentication target. The authentication system library uses version information indicating a version number of the authentication system library, authentication type information indicating an authentication method (authentication program) used in the authentication processing of the authentication target, and arrangement order type information indicating an arrangement order of a plurality of authentication information so as to form an authentication information header block (refer to FIG. 5).

Next, the authentication system library forms an information number block (refer to FIG. 5) indicating the number (n) of the acquired authentication information by referring to the number of the acquired authentication information. When the information number block is formed, the authentication system library arranges a plurality of the acquired authentication information in an arrangement order indicated by the arrangement order type information so as to form an authentication information block (refer to FIG. 5). When the authentication information header block, the information number block, and the authentication information block are formed, the authentication system library packetizes these blocks, and forms the authentication information packet to transmit it to the authentication server machine 1. When a plurality of authentication information are arranged, the authentication system library may arrange a plurality of authentication information by mixing dummy blocks which are not the authentication information according to user's instruction or settings, and form the authentication information block.

Here, arrangement order types for the above each arrangement order is determined in advance by a table shown in FIG. 6, and the authentication system library arbitrarily selects the arrangement order type, and refers to this table to arrange a plurality of authentication information in the order corresponding to the selected arrangement order type.

The example of the table in FIG. 6 is an example used when the authentication target is a credit card of the user, where a first to third arrangement order types, and three type of the authentication information such as a credit card number (16 bit-long), an expiration date of credit card (8 bit-long), and a user name (4 bit-long) are prescribed. Further, numerals of “1”, “2”, and “3” in the drawing denote the arrangement order of the authentication information.

In the case where the authentication information are arranged according to the table shown in FIG. 6, when the first arrangement order type is selected, the authentication system library arranges the authentication information in the order of the 16 bit-long credit card number, the 8 bit-long expiration date of credit card to form the 24 bit-long authentication information block. Further, similarly, the authentication system library arranges the authentication information in the order of the 4 bit-long user name and the 16 bit-long credit card number when the second arrangement order type is selected, and in the order of the 4 bit-long user name, the 8 bit-long expiration date of credit card, and the 16 bit-long credit card number when the third arrangement order type is selected to form the 20 bit-long and 28 bit-long authentication information block.

As described above, since the above client terminal device 2 arranges a plurality of authentication information in the arbitrary order to transmit it to the authentication server machine 1 side, even when the authentication information packet is intercepted by the third party, it is prevented that the authentication information is separated from the inside of the authentication information packet and individually read out, so that the data communication can be safely performed. Further, when the authentication information is arranged by mixing the dummy blocks which are not the authentication information, it is possible to make it difficult that the authentication information is correctly read out, so that the data communication can be performed more safely.

Authentication Processing Operation of Authentication Server Machine

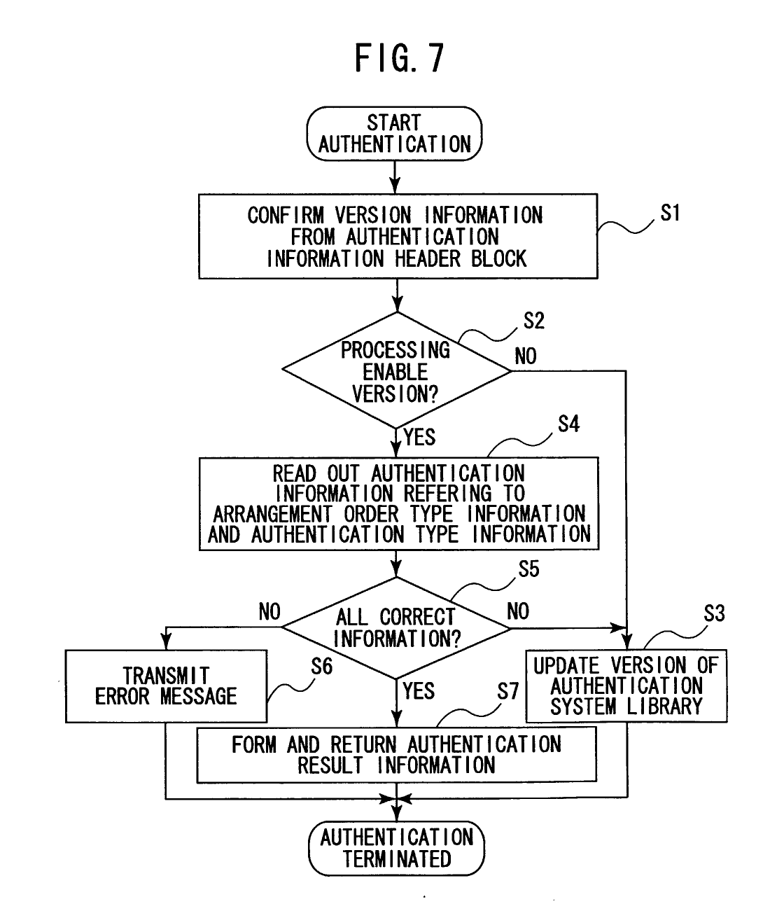

Next, with reference to the flow chart shown in FIG. 7, the authentication information packet transmitted from the client terminal device 2 is utilized to describe an operation of the authentication server machine 1 when the authentication processing of the authentication target is performed.

The flow chart show in FIG. 7 starts when the authentication server machine 1 receives the authentication information packet transmitted from the client terminal device 2 of the user, and this processing proceeds to a processing of step S1.

In the processing of step S1, the authentication server machine 1 reads out the version information of the authentication system library from the authentication information header block of the received authentication information packet. Thereby, the processing of step S1 is completed, and this authentication processing proceeds from the processing of step S1 to a processing of step S2.

In the processing of step S2, the authentication server machine 1 refers to the version information of the authentication system library read out from the authentication information header block, and determines whether or not the authentication system library is a version in which the authentication processing can be performed. As a result of the determination, in the case of a version in which the authentication processing can be performed, the authentication server machine 1 advances this authentication processing from the processing of step S2 to a processing of step S4. On the other hand, in the case of a version in which the authentication processing cannot be performed, the authentication server machine 1 advances this authentication processing from the processing of step S2 to a processing of step S3.

The authentication server machine 1 comprises the authentication program corresponding to the authentication system library of the past version so that the authentication processing can be also performed in correspondence to the authentication system library of the past version, and is configured so that the authentication processing is not performed with respect to the authentication system library of a specific version.

In the processing of step S3, the authentication server machine 1 downloads the authentication system library of a new version in which the authentication processing can be performed into the client terminal device 2, and updates the authentication system library of the client terminal device 2 side. Thereby, the client terminal device 2 is enabled to receive the authentication processing at the next and succeeding times, so that a series of authentication processings is completed.

When the authentication system library is updated, the authentication server machine 1 may transmit an error message such as “install authentication system library of new version, and retry authentication processing application” to the client terminal device 2, and update the authentication system library according to a start instruction from the client terminal device 2. Further, the user may install the authentication system library of the new version from the storage medium (for example, a CD-ROM, a DVD-ROM, or the like) into the client terminal device 2 by himself or herself.

In the processing of step S4, the authentication server machine 1 refers to the arrangement order type information and the authentication type information in the authentication information header block, and specifies and reads out the respective authentication information in the authentication information block. In the case the respective authentication information can be specified only by the arrangement order type information, the authentication server machine 1 may not refer to the authentication type information. Specifically, the authentication server machine 1 stores a table having the same configuration as shown in FIG. 6 in authentication DB beforehand, and when the authentication system library of the client terminal device 2 refers to the table shown in FIG. 6 to arrange the authentication information, the authentication server machine 1 collates the arrangement order type indicated by the arrangement order type information with the arrangement order type indicated by the table in the authentication DB. The authentication server machine 1 reads out the respective authentication information in the authentication information block by referring to an arrangement order corresponding to collated arrangement order type. For example, when the arrangement order type is the third arrangement order type shown in FIG. 6 and a credit card number, an expiration date of credit card, and a user name are 16, 8, and 4 bit-long respectively, the authentication server machine 1 reads out the first 4 bit-long data of the 28 bit-long authentication information block as use name, the next 8 bit-long data as expiration date, and the last 16 bit-long data as credit card number. Thereby, the processing of step S4 is completed, and this authentication processing proceeds from the processing of step S4 to a processing of step S5.

In the processing of step S5, the authentication server machine 1 performs the authentication processing of the respective recognized authentication information according to the authentication method indicated by the authentication type information included in the authentication header block. Specifically, when the authentication server machine 1 reads out three types of items of authentication information such as the credit card number, the expiration date of credit card, and the user name, the authentication server machine 1 compares the recognized information with the information such as the credit card number, the expiration date of credit card, and the user name stored in advance, thereby performs the authentication processing of the respective authentication information. When the authentication of all the authentication information has succeeded, this authentication processing proceeds from the processing of step S5 to a processing of step S7. On the other hand, when the authentication of part of or all the authentication information fails, this authentication processing proceeds from the processing of step 5 to a processing of step S6.

When the authentication server machine 1 has a plurality of authentication programs in the authentication DB, the authentication server machine 1 selects the authentication program designated by the authentication type information from among a plurality of authentication programs, and performs the authentication processing of the authentication information on the basis of the selected authentication program.

In the processing in step S6, the authentication server machine 1 transmits an error message such as, for example, “authentication not performed” to the client terminal device 2 of the user. In this case, the authentication has not been performed with respect to the authentication target desired by the user, so that a series of authentication processings is terminated.

Instep S7, the authentication server machine 1 transmits the authentication result to the client terminal device 2 of the user. Thereby, the processing in step S7 is completed, so that a series of authentication processings is terminated.

As described above, the authentication server machine 1 refers to the version information of the authentication system library notified by the client terminal device 2 so as to perform the authentication processing of authentication target. According to such a configuration, the client terminal device 2 can appropriately change the version of the authentication system library, and at the same time, the authentication server machine 1 can flexibly correspond to the version change of the authentication system library at the client terminal device 2 side.

Further, the client terminal device 2 sends the arrangement order type information indicating arrangement order for a plurality of authentication information together with a plurality of authentication information arranged in arbitrary order, the authentication server machine 1 can reads out the respective authentication information comprising authentication information block correctly.

Further, since the authentication server machine 1 stores a plurality of authentication program in authentication DB, the authentication server machine 1 can flexibly correspond to the new authentication method, and, at the same time, can correct and modify the authentication method at ease by correcting and modifying the authentication program.

Authentication Result Notification Operation of Authentication Server Machine

When the authentication result is transmitted to the client terminal device 2, the authentication server machine 1 may arrange a plurality of authentication result information in an arbitrary order, and transmit them as the authentication result information packet to the client terminal device 2 side similarly to when the client terminal device 2 transmits the authentication information packet to the authentication server machine 1. According to such a processing, for example, even when the authentication result information packet is intercept by the third party, it is prevented that the authentication result information is separated from the inside of the authentication result information packet to be individually read out, so that the data communication can be safely performed.

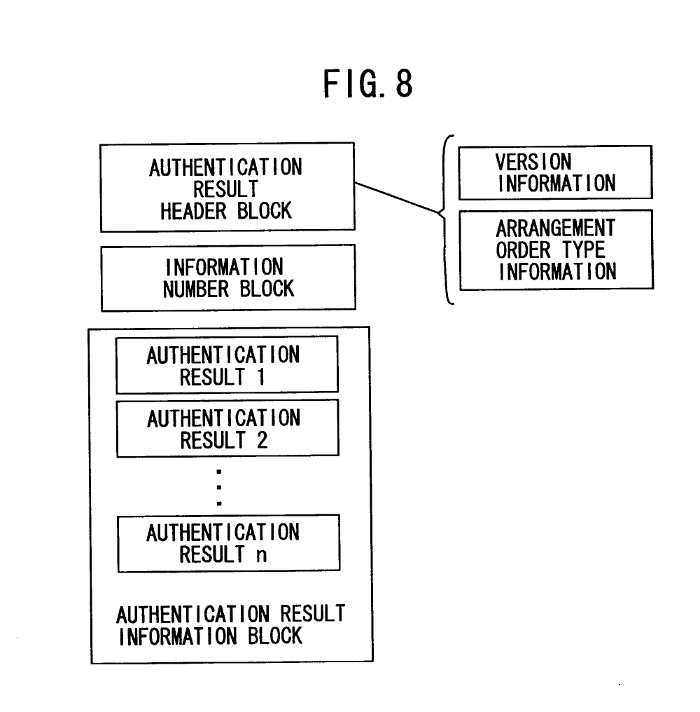

In this case, in a specific manner as shown in FIG. 8, the authentication server machine 1 packetizes the authentication result header block, the information number block indicating the number of the authentication result information, and the authentication result information (authentication result information 1 to authentication result information n (n shows natural number)) block indicating a plurality of authentication results to form the authentication result information packet. Here, the authentication result header block is configured with the version information indicating the version number of the authentication processing program at the authentication server machine 1 side, and the arrangement order type information indicating the arrangement order of a plurality of items of authentication result information transmitted to the client terminal device 2 side of the user. Further, the number of authentication result information is changed according to the authentication program designated by the authentication type information, and the authentication result information for the number formed according to the authentication program is stored.

When the client terminal device 2 of the user receives such an authentication result information packet, the client terminal device 2 recognizes the respective authentication result information in the authentication result information block according to the arrangement order indicated by the arrangement order type information in the authentication result header. The client terminal device 2 performs a predetermined processing corresponding to the authentication target on the basis of the identification authentication result information.

### APPLICATION EXAMPLE

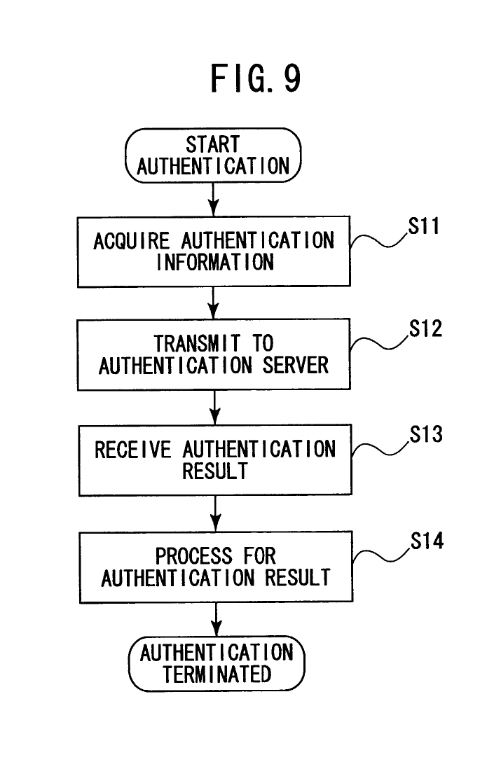

The above-mentioned authentication system can be applied to the license authentication of software (application). As shown in the flow chart of FIG. 9, in this case, the authentication system library of the client terminal device 2 acquires a plurality of IDs corresponding to the software for which the license authentication is applied (step S11), and forms the authentication information packet. And, the authentication system library sends the formed authentication information packet to authentication server machine 1 (step S12).

Further, as the ID to be acquired by the authentication system library, the user specifiable information is preferable. As an example, for example, the MAC address can be employed. Further, the ID may be manually input by the user, alternatively the existing ID may be selected.

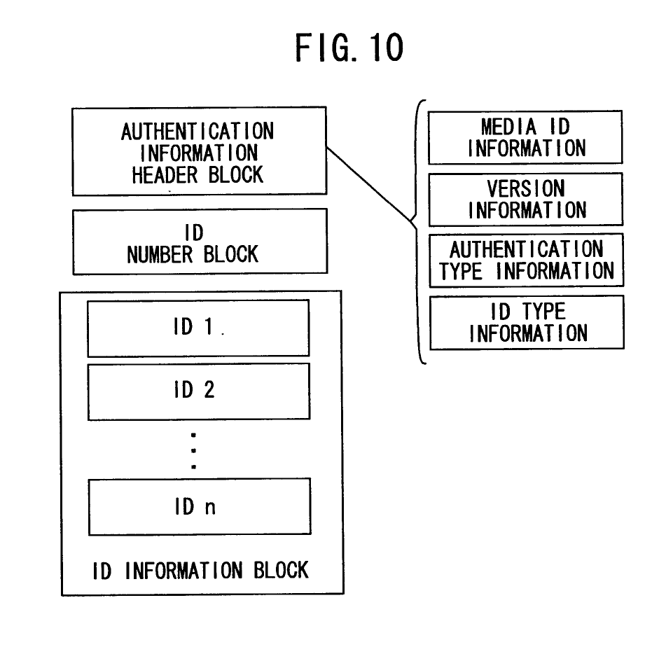

In the case the license authentication of software (application) is performed, the authentication system library forms authentication information packet like the configuration shown in FIG. 10. The authentication information packet shown in FIG. 10 comprises a media ID for specifying the software for which the license authentication is applied, the version information indicating the version of the authentication system library used at the client terminal device 2 side, the authentication type information for designating the authentication program corresponding to the software, and the ID type information for designating the type of the acquired ID and the arrangement order of the acquired ID in authentication header block unlike the authentication information packet shown in FIG. 5. As the ID number information block and ID information block is the same configuration as the information number block and the authentication information block shown in FIG. 5, the explanation thereof is simplified.

In receiving the authentication information packet, the authentication server machine 1 reads out ID information from ID information block by referring to ID type information in the authentication header block, and performs the authentication processing on the basis of the respective ID information. Then, the authentication server machine 1 issues one or a plurality of registration IDs when the license is authenticated, packetizes the registration IDs together with the information indicating the authentication result (authentication result information packet: FIG. 13), and sends it to the client terminal device 2.

When this authentication result information packet is received in step S13, the client terminal device 2 performs the processing corresponding to the authentication result of the software of which the user has applied for the license authentication in step S14. Specifically, when the received authentication result is the negative authentication result with respect to the license application of the software, the client terminal device 2 performs the indication of the error message for the monitor device such as “license has not been authenticated” indicating that the license has not been authenticated. In such a negative authentication result, the user cannot legitimately use the software. On the contrary, when the received authentication result is the positive authentication result with respect to the license application of the software, the client terminal device 2 performs the following processings on the basis of the registration ID issued at the authentication server machine 1.

At first, until the license is authenticated, when the install of the application program stored in the software is not permitted, this protect is released, and a processing is performed in which the install of the application program is enabled. Further, until the license is authenticated, when part of the functions of the application program installed from the software is restricted, a processing is performed in which the part of the functions restricted in use is made usable and all the functions are made usable. As described above, the user who has been authenticated for the license for the software can substantially freely use the application program of the software.

As described above, since the above client terminal device 2 arranges a plurality of IDs corresponding to the software that license authentication is applied in the arbitrary order so as to transmit it to the authentication server machine 1 side, even when the authentication information packet is intercepted by the third party, it is prevented that the Ids is separated from the inside of the authentication information packet and individually read out, so that the data communication can be safely performed.

Further, the client terminal device 2 sends the ID type information indicating the arrangement order for a plurality of IDs together with a plurality of IDs arranged in arbitrary order, the authentication server machine 1 can read out the respective ID comprising ID information block correctly.

License Authentication Operation of Authentication Server Machine

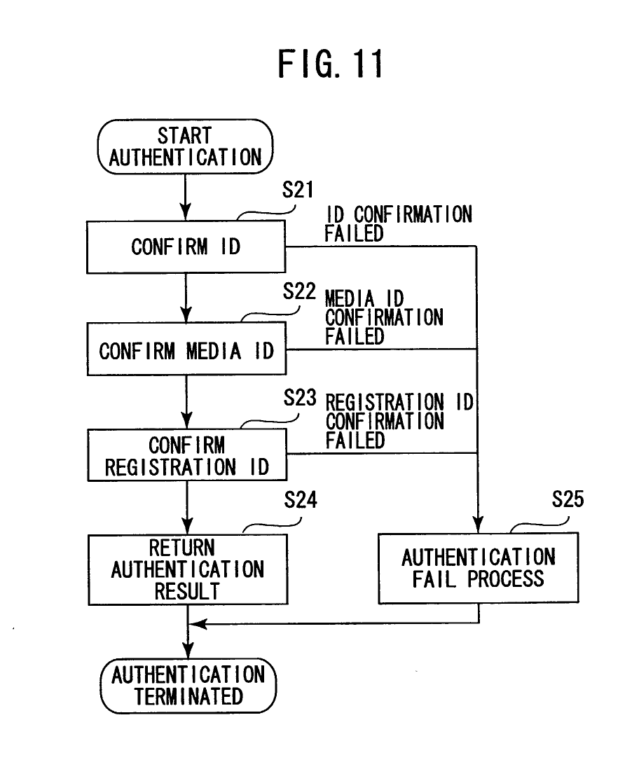

In response to receiving the authentication information packet, the authentication server machine 1 performs the license authentication as follows. In the following, the operation of the authentication server machine 1 when performing the license authentication is explained with reference to the flow chart shown in FIG. 11.

When this flow chart starts, the authentication server machine 1 reads out the authentication type information in the received authentication information packet at first, and performs the following license authentication processing on the basis of the authentication program designated by this authentication type information. The flow of the license authentication processing depends on the authentication program designated by the authentication type information. Therefore, understand that the flow of the license authentication processing described later is a case where the authentication program corresponding to this flow is designated as the authentication program of the software and is nothing but an example.

In other words, in the case of this example, in step S21, the authentication server machine 1 performs a confirmation processing of each ID in the received authentication information packet. Specifically, in this case, in the authentication DB of the authentication server machine 1, the respective IDs with respect to the client terminal device 2, the peripheral devices thereof, and the like used by each user are registered in advance, and the authentication server machine 1 manages each user by a cluster of respective IDs (ID group).

Therefore, in step S21, the authentication server machine 1 collates the respective IDs in the received authentication information packet with the respective IDs in the ID group of the users in the authentication DB, respectively, when the respective IDs in the received authentication information packet are entirely coincided with the respective IDs of the ID group in the authentication DB, this license authentication processing is advanced to step S23. When even one of the respective IDs in the received authentication information packet is not coincided with each ID of the ID group in the authentication DB, this license authentication processing is advanced to step S25.

In step S25, since there is a difference between the respective IDs of the above authentication information packet and the respective IDs of the ID group of the user stored in the authentication DB, the authentication server machine 1 returns the error message such as, for example, “license cannot be authenticated” or the like to the client terminal device 2 and terminates the license authentication processing shown in the flow chart in FIG. 11.

Next, when this license authentication processing is advanced to step S22, the authentication server machine 1 performs the confirmation processing of the media ID for confirming whether or not the media ID uniquely added to the software which is the authentication target of the license for the user is a legitimate media ID. Specifically, in the authentication DB of the authentication server machine 1, the unique IDs respectively added to the respective media produced by the software maker are all stored. Therefore, when the media ID is read out from the authentication header, the authentication server machine 1 collates the read media ID with each ID stored in the authentication DB.

Since that the media ID read from the authentication DB does not exist in the respective IDs stored in this authentication DB means that the media ID read from the authentication header is not the legitimate media ID, the authentication server machine 1 advances this license authentication processing to step S25. In this step S25, the error message such as, for example, “license cannot be authenticated” is returned to the client terminal device 2 so that the license authentication processing shown in the flow chart in FIG. 11 is terminated.

On the contrary, since that the media ID read from the authentication header exists in the respective media IDs stored in the authentication DB means that the media ID read from the authentication header is the legitimate media ID, the authentication server machine 1 advances the license authentication processing to the confirmation processing of the registration ID described later.

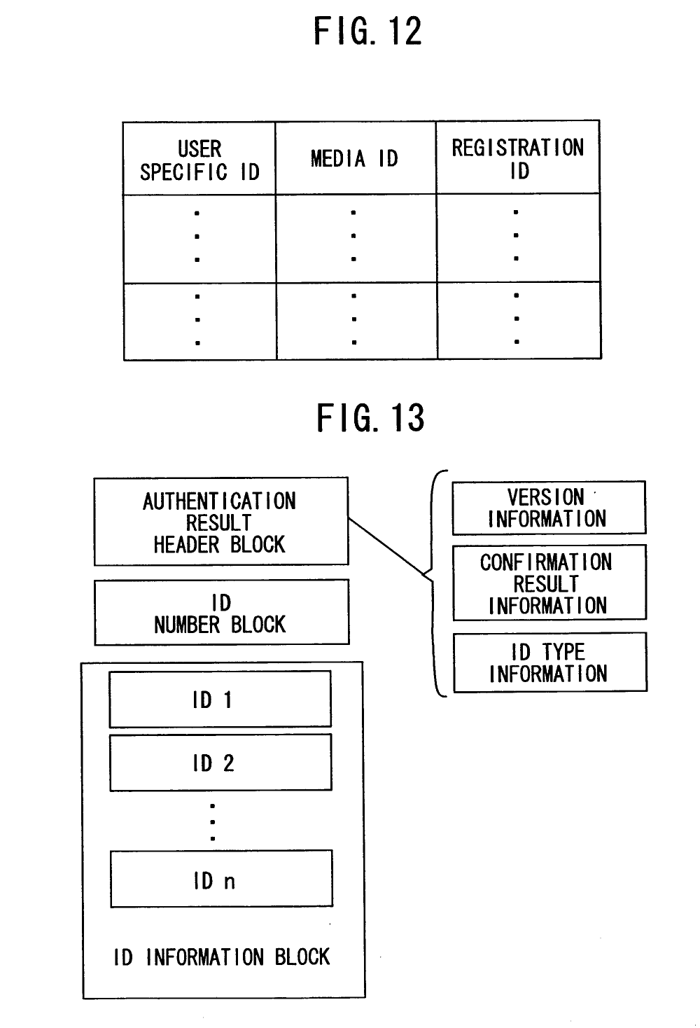

In step S23, the authentication server machine 1 performs the confirmation processing of the registration ID for confirming whether or not the registration ID has already been issued to the software which is the authentication target of the license for the user. Specifically, the authentication DB of the authentication server machine 1 is provided with, as shown in FIG. 12, the registration ID management table comprising the ID for specifying each user in the above ID group or the like, the media ID of the software license-authenticated for the user, the registration ID issued when the license authentication has been performed for the software, and the like.

Therefore, the authentication server machine 1 specifies the user by referring to the registration ID management table on the basis of the above ID group, and detects whether or not the registration ID has already been issued for the software having the media ID on the basis of the media ID added to the authentication information header.

Since that the registration ID for the media ID is not stored in the registration ID management table means that the registration ID has not been issued to the software having the media ID, the authentication server machine 1 refers to the application management table described with reference to FIG. 3 and selects the ID issue program designated for the software having the media ID from among a plurality of ID issue programs provided as shown in FIG. 2, on the basis of the media ID added to the authentication information header.

On the basis of the selected ID issue program, one or a plurality of new registration IDs are issued, and the issued registration IDs are stored in the registration ID management table. The registration ID stored in this registration ID management table is to be used for the confirmation processing of the registration ID, hereinafter.

On the contrary, since that the registration ID for the media ID is stored in the registration ID management table means that the registration ID has been already issued for the software having the media ID, the authentication server machine 1 advances this license authentication processing to step S25, and returns the error message such as, for example, “the license for the software has been already authenticated” to the client terminal device 2, so that the license authentication processing shown in the flow chart in FIG. 11 is terminated.

For example, when the registration ID exists (has been used) for the software having the media ID, other processings may be performed. For example, the use of the application program is permitted only in a predetermined period as a trial period. These processings also depend on the authentication programs.

Next, when such a confirmation processing of the registration ID is terminated, the authentication server machine 1 forms the confirmation result information packet, and returns it to the client terminal device 2 of the user.

FIG. 13 shows a schematic diagram of this confirmation result information packet. As shown in FIG. 13, the confirmation result information packet is configured as a result that the authentication result header, the ID number information indicating the number of the issued registration IDs, and one or a plurality of registration IDs (ID1 to IDn: n is natural number) are packetized. The example shown in FIG. 13 is an example in which a plurality of registration IDs is issued. Further, the registration ID added succeeding to the ID number information which is the information indicating the number of the issued registration IDs is configured to be added for the number indicated by this ID number information.

The authentication result header is configured with the version information indicating the version of the authentication program used when the authentication information from the client terminal device 2 is processed at the authentication server machine 1 side, the confirmation result information (confirmation result) respectively indicating the authentication information confirmation result acquired in the above step S21, the media ID confirmation result acquired in step S22, and the registration ID confirmation result acquired in step S23, and the ID type information (ID type) for designating the arrangement order of the issued registration ID. The ID type information is the information for designating the ID type indicating the arrangement order of the issued ID from among a plurality of ID types such as, for example, a first ID type to a third ID type as described with reference to FIG. 6.

When the client terminal device 2 receives such authentication result information, the client terminal device 2 uses the processing program of the version designated by the version information of this authentication result information to read out the respective registration IDs according to the arrangement order designated by the ID type information and to store and control this registration ID in the secondary storage medium such as, for example, a HDD, on the basis of the authentication system library.

According to the authentication result information of the authentication result header, the install of the application program of the license-authenticated software is enabled, alternatively, part of or all the functions restricted so far are enabled by the installed application program. Thereby, the license authentication in the authentication server machine 1 and the client terminal device 2 is legitimately terminated, so that the user can substantially freely the desired application program.

As described above, in performing the license authentication of software, the authentication server machine 1 arranges a plurality of registration IDs corresponding to the software that license authentication is performed in the arbitrary order so as to transmit it to the client terminal device 2 side, even when the authentication result information packet is intercepted by the third party, it is prevented that the IDs is separated from the inside of the authentication result information packet and individually read out, so that the data communication can be safely performed.

Further, since the authentication server machine 1 stores a plurality of ID issue program in the authentication DB, the authentication server machine 1 can flexibly correspond to the new ID issue method, and, at the same time, can correct and modify ID issue method by correcting and modifying ID issue program.

Other Embodiment

Hereinbefore, the embodiment to which the invention made by the present inventors is applied is described, but the present invention is not limited by the descriptions and the drawings which form part of the disclosure of the present invention according to the embodiment.

For example, in the description of the above embodiment and application example, the license authentication is performed at the install of the application program or at the function restriction release of the installed application program, but the above license authentication may be imposed on the user, for example, when the program of the predetermined function is downloaded and added to the installed application program through an online service, or the like.

Further, the table for prescribing a relationship between the type of the authentication information to be acquired and the arrangement order of the respective acquired authentication information may be used fixedly in the state where the authentication system library remains installed in the client terminal device 2, and may be used while being downloaded from the authentication server machine 1 or the like and being dynamically updated.

Further, the type of the arrangement order type or the number of items of authentication information prescribed in the above table and the arrangement order of the authentication information may be appropriately changed according to a design of the authentication system and the like.

Further, a timing of the above license authentication may be set to an arbitrary timing according to the authentication target.

Therefore, even other embodiments than the above embodiment may be employed, and various modifications can be performed according to the design and the like without departing from the technical spirit of the present invention.

What is claimed is:

1. An authentication method comprising the steps of:
receiving specific information for specifying an authentication target for which an authentication application is performed;
receiving user specific information for specifying a user who is applying for an authentication;
selecting an authentication program corresponding to an authentication target indicated by the specific information; and
performing an authentication processing for the authentication target on the basis of the selected authentication program for a user indicated by the user specific information.

2. An authentication method according to claim 1, comprising the steps of:
selecting an identification information issue program corresponding to an authentication target indicated by the specific information; and
performing an issue processing of authentication identification information indicating that an authentication of the authentication target has been performed on the basis of the selected identification information issue program.

3. An authentication method according to claim 1, comprising the steps of:
receiving a plurality of identification information used for an authentication processing of an authentication target transmitted in an arbitrary order, and order information indicating the arbitrary order; and
recognizing received identification information by referring to the order information,
wherein the authentication processing is performed on the basis of the recognized identification information.

4. An authentication method according to claim 3, wherein the plurality of identification information is acquired from a client terminal device or a client terminal device and peripheral devices of a user.

5. An authentication method according to claim 2, comprising the steps of:
performing an issue processing of a plurality of authentication identification information indicating that an authentication of the authentication target has been performed;
forming designation information for designating a transmission order of the plurality of issued authentication identification information; and
returning the designation information together with the plurality of authentication identification information to a client terminal device of a user who has performed an authentication application.

6. An authentication method according to claim 1, comprising the steps of:
receiving version information of an authentication system library of a client terminal device side which has formed at least the specific information; and
performing the authentication processing corresponding to a version indicated by the version information.

7. A computer readable storage medium having stored therein an authentication program to be executed on a computer, wherein the authentication program comprises the steps of:
receiving specific information for specifying an authentication target for which an authentication application is performed;
receiving user specific information for specifying a user who is applying for an authentication;
selecting an authentication program corresponding to an authentication target indicated by the specific information; and
performing an authentication processing for the authentication target on the basis of the selected authentication program for a user indicated by the user specific information.

8. A computer readable storage medium having stored therein an authentication program according to claim 7, wherein the authentication program further comprises the steps of:
selecting an identification information issue program corresponding to an authentication target indicated by the specific information; and
performing an issue processing of authentication identification information indicating that an authentication of the authentication target has been performed on the basis of the selected identification information issue program.

9. A computer readable storage medium having stored therein an authentication program according to claim 7, wherein the authentication program further comprises the steps of:
receiving a plurality of identification information used for an authentication processing of an authentication target transmitted in an arbitrary order, and order information indicating the arbitrary order;
recognizing the respective identification information by referring to the order information; and
performing the authentication processing on the basis of the recognized identification information.

10. A computer readable storage medium having stored therein an authentication program according to claim 9, wherein the plurality of identification information is acquired from a client terminal device or a client terminal device and peripheral devices of a user.

11. A computer readable storage medium having stored therein an authentication program according to claim 8, wherein the authentication program further comprises the steps of:
performing an issue processing of a plurality of authentication identification information indicating that an authentication of the authentication target has been performed;
forming designation information for designating a transmission order of the plurality of issued authentication identification information; and
returning the designation information together with the plurality of authentication identification information to a client terminal device of a user who has performed an authentication application.

12. A computer readable storage medium having stored therein an authentication program according to claim 7, wherein the authentication program further comprises the steps of:
receiving version information of an authentication system library of a client terminal device side which has formed at least the specific information; and
performing the authentication processing corresponding to a version indicated by the version information.

13. An authentication program to be executed on a computer, comprising the steps of:
receiving specific information for specifying an authentication target for which an authentication application is performed;
receiving user specific information for specifying a user who is applying for an authentication;
selecting an authentication program, corresponding to an authentication target indicated by the specific information; and
performing an authentication processing for the authentication target on the basis of the selected authentication program for a user indicated by the user specific information.

14. An authentication server machine comprising:
a receiving unit for receiving at least specific information for specifying an authentication target for which an authentication application is performed, and user specific information for specifying a user who is applying for an authentication;
an authentication program selecting unit for selecting an authentication program corresponding to an authentication target indicated by specific information received by the receiving unit; and
an authentication processing unit for performing an authentication processing for the authentication target on the basis of an authentication program selected by the authentication program selecting unit for a user indicated by user specific information received by the receiving unit.

15. An authentication server machine according to claim 14, further comprising:
an issue program selecting unit for selecting an identification information issue program corresponding to an authentication target indicated by the specific information,
wherein the authentication processing unit performs the authentication processing, and issues authentication identification information indicating that an authentication of the authentication target has been performed and returns it to a user on the basis of an identification information issue program selected by the issue program selecting unit.

16. An authentication server machine according to claim 14,
wherein the receiving unit receives a plurality of identification information used for an authentication processing of an authentication target transmitted in an arbitrary order, and order information indicating the arbitrary order, and comprises a recognizing unit for recognizing the respective identification information by referring to the order information, and
the authentication processing unit performs the authentication processing on the basis of identification information recognized by the recognizing unit.

17. An authentication server machine according to claim 16, wherein the receiving unit receives a plurality of identification information acquired from a client terminal device or a client terminal device and peripheral devices of a user.

18. An authentication server machine according to claim 15, further comprising:
an issuing unit for issuing a plurality of authentication identification information indicating that an authentication of the authentication target has been performed; and
a designation information forming unit for forming designation information for designating a transmission order of a plurality of authentication identification information issued by the issuing unit,
wherein the authentication processing unit returns the designation information together with the plurality of authentication identification information to a client terminal device of a user who has performed an authentication application.

19. An authentication server machine according to claim 14,
wherein the receiving unit receives version information of an authentication system library of a client terminal device side which has formed at least the specific information, and
the authentication processing unit performs the authentication processing corresponding to a version indicated by the version information.

20. A client terminal device comprising:
a specific information forming unit for forming specific information for specifying an authentication target for which an authentication is applied;
a user specific information forming unit for forming user specific information for specifying a user who applies for an authentication;
an identification information acquiring unit for acquiring a plurality of identification information from the client terminal device or the client terminal device and peripheral devices;
a designation information forming unit for forming designation information for designating a transmission order of a plurality of identification information acquired by the identification information acquiring unit; and
a transmitting unit for transmitting the specific information, the user specific information, a plurality of identification information, and designation information.

21. A client terminal device according to claim 20, wherein the transmitting unit transmits version information of an authentication system library for performing formation, acquisition, and transmission of the specific information, the user specific information, the plurality of identification information, and the designation information.

22. An authentication system comprising:
a client terminal device connected to a predetermined network for transmitting at least information for specifying a user and information for specifying an authentication target for which an authentication is applied when an authentication application of an authentication target is performed; and
an authentication server machine for specifying a user on the basis of the information for specifying a user when an authentication application is performed from the client terminal device side, and performing an authentication processing for the specified user by selecting an authentication program corresponding to an authentication target for which an authentication application has been performed on the basis of the information for specifying an authentication target, and returning this authentication information to the client terminal of the user.

23. An authentication system according to claim 22,
wherein the authentication server machine has an identification information issue program for each authentication target, and
the authentication server machine selects an identification information issue program corresponding to the authentication target for which an authentication application has been performed and issues identification information of an information form corresponding to the authentication target for which an authentication application has been performed to the specified user.

24. An authentication system according to claim 2223,
wherein the client terminal device has an authentication system library corresponding to the system, and
the client terminal device acquires the information for specifying a user from a client terminal device used by a user, or acquires the information for specifying a user from a client terminal device and peripheral devices of a user on the basis of the authentication system library.

25. An authentication system according to claim 24,
wherein the client terminal device arranges information for specifying a plurality of users acquired from a client terminal device used by a user or a client terminal device and peripheral devices used by a user in a arbitrary order, and transmits it together with information indicating the arbitrary order of the information to the authentication server machine, and
the authentication server machine refers to the information indicating the arbitrary order, and recognizes information for specifying a user transmitted from the client terminal device to use it for an authentication.

26. An authentication system according to claim 25, wherein the client terminal device selects one arrangement order from among a plurality of patterns of arrangement order, and arranges the information for specifying a user according to this selected arrangement order.

27. An authentication system according to any one of claim 22,
wherein at least the information for specifying a user, and version information of an application program for forming and controlling information for specifying an authentication target for which an authentication is applied are added to the information transmitted from a client terminal device to an authentication server machine, and
the authentication server machine performs an authentication processing corresponding to a version of an application program of the client terminal device.
